(19) United States
(12) Patent Application Publication
(10) Pub. No.: US 2017/0003738 A1
(43) Pub. Date: Jan. 5, 2017

(54) SYSTEMS AND METHODS FOR IMMERSIVE PHYSICAL INTERACTION WITH A VIRTUAL ENVIRONMENT

(71) Applicant: Survios, Inc., Culver City, CA (US)

(72) Inventors: Alexander Silkin, Los Angeles, CA (US); Nathan Burba, Los Angeles, CA (US); Eugene Elkin, Los Angeles, CA (US)

(21) Appl. No.: 15/181,709

(22) Filed: Jun. 14, 2016

Related U.S. Application Data
(60) Provisional application No. 62/175,759, filed on Jun. 15, 2015.

(51) Int. Cl. G06F 3/01; A63F 13/216; A63F 13/42; A63F 13/213; G06F 3/0484; A63F 13/211

(52) U.S. Cl. CPC G06F 3/011; G06F 3/017; G06F 3/04845; A63F 13/211; A63F 13/42; A63F 13/213; A63F 13/216; G06T 13/40

(57) ABSTRACT

A system for immersive physical interaction includes a hand position and orientation tracker that tracks a first hand position and a first hand orientation of a first hand of a user and tracks a second hand position and a second hand orientation of a second hand of the user; a physical criteria generator comprising a body physics simulator that simulates avatar motion and a constrained object interaction system that manages virtual object coupling; and an input translator that translates the first hand position and the first hand orientation into a first virtual hand position and a first virtual hand orientation of a user avatar in a virtual environment and translates the second hand position and the second hand orientation into a second virtual hand position and a second virtual hand orientation of the user avatar.

### CROSS-REFERENCE TO RELATED APPLICATIONS

This application claims the benefit of U.S. Provisional Application No. 62/175,759, filed 15 Jun. 2015, which is incorporated in its entirety by this reference.

### TECHNICAL FIELD

This invention relates generally to the virtual reality field, and more specifically to new and useful systems and methods for immersive physical interaction with a virtual environment.

### BACKGROUND

It was the early 1990s, and virtual reality (VR) had arrived. VR gaming systems populated arcades and movie theaters across the country; IBM announced Project Elysium, a “complete integrated VR workstation” for use by architects and builders. At the time, VR seemed poised to be the next big thing in computing. Unfortunately, the complex controls and underwhelming graphics of 90's VR systems prevented virtual reality from living up to its full potential, and the ‘VR revolution’ quickly fizzled out.

Over twenty years later, virtual reality is back in a big way. Soon, consumer VR hardware will be able to display virtual worlds so detailed that they are almost indistinguishable from reality. Yet, for all the progress that has been made in VR, most systems and methods used to enable interaction with these virtual worlds bear a striking resemblance to those of 1991.

To address this issue, recent work in the virtual reality field has focused on enabling interaction with virtual worlds through natural motion. This is a great step forward in VR technology; but for natural motion to truly capture a user's imagination, the results of user interaction must feel as natural as the motion that initiated the interaction. Thus, there exists a need in the virtual reality field to create new and useful systems and methods for immersive physical interaction with a virtual environment. This invention provides such new and useful systems and methods.

### BRIEF DESCRIPTION OF THE FIGURES

FIG. 1 is a schematic representation of a system of a preferred embodiment;

FIG. 2A is a top view of a hand controller of a system of a preferred embodiment;

FIG. 2B is a front view of a hand controller of a system of a preferred embodiment;

FIG. 2C is a side view of a hand controller of a system of a preferred embodiment;

FIG. 2D is a back view of a hand controller of a system of a preferred embodiment;

FIG. 3 is a diagram view of a physical criteria generator of a system of a preferred embodiment;

FIG. 4 is a diagram view of an avatar skeleton;

FIGS. 5A and 5B are example views of an avatar perspective before and after avatar translation respectively;

FIG. 6 is an example view of object interaction points and motion constraints;

FIG. 7 is an example view of object motion constraints;

FIG. 8 is an example view of object interaction points and motion constraints;

FIG. 9 is an example view of a virtual panel system;

FIG. 10A and FIG. 10B are example view of user input translation refinement;

FIG. 11 is a chart view of a method of a preferred embodiment;

FIG. 12 is a chart view of monitoring user interaction of a method of a preferred embodiment;

FIG. 13 is a chart view of receiving a set of constrained physical interaction criteria of a method of a preferred embodiment.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

1. Realism vs. Immersion

You look around. Behind you, you see nothing but inhospitable desert terrain. In front of you, the rocky slopes of a scrub-covered gorge fall away to reveal a village in the distance. You know your target is somewhere in that village, but where? Even your binoculars are of no use at this distance. You're deep in enemy territory; here, the price of detection is death. So you crawl. You crawl for hours. Your fingers start to cramp from holding down the ‘w’ key; but you're committed to the cause. Eventually, you make it to the designated spot without raising alarm. Now, the real work begins.

You unpack your sniper rifle. You know the range to the target's front door, so you pull out a calculator to determine the elevation adjustment to the rifle scope; you'll need this to score an accurate hit. Next, you measure wind speed and calculate a windage adjustment. You adjust the scope accordingly, and press the right mouse button to peer through the optics to the house below. Again, hours pass, and night falls in the desert. You're starting to wonder why you're still playing this video game when the target finally appears under your reticle. Your heart catches in your throat as you press the left mouse button to take the shot. You miss. Game over.

In the debriefing screen that follows, the game would tell you that you forgot to adjust for the fact that when night falls in the desert, temperatures can drop dramatically. This temperature change results in cartridge powder burning more slowly, which in turn results in your shot striking low. Of course, it's difficult to read the debriefing screen after you've tossed the computer out your window.

Making a good video game requires capturing the essence of realistic interaction without including distracting and extraneous details—a test the preceding example clearly fails. This example highlights the importance of this distillation process for narrative immersion, but similar processes are just as important for sensory immersion.

The advent of motion tracking technology has the potential to bring enhanced sensory immersion to interaction with virtual reality (VR) and augmented reality (AR) systems, but in order to realize the benefits of sensory immersion, motion-based interaction must be interpreted by VR/AR systems in a way that feels natural, instead of laborious.

The systems and methods of the present application are directed to enabling immersive physical interaction with a virtual environment by capturing physical input and distilling the essence of that input into interaction, creating a truly natural-feeling experience for a user.

### 2. System for Immersive Physical Interaction

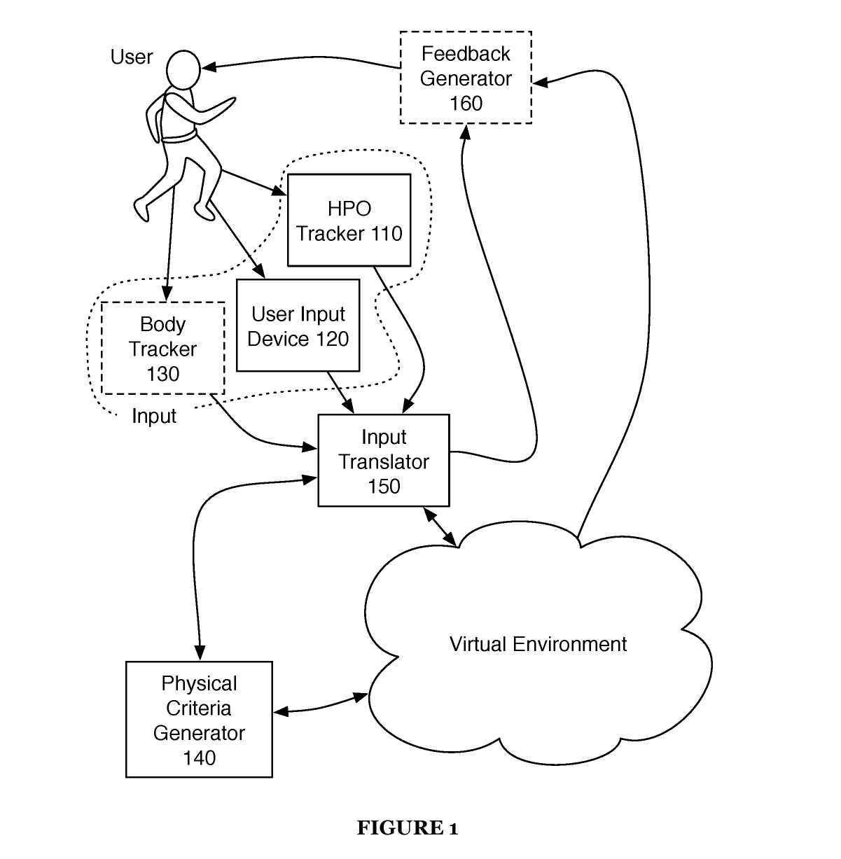

A system 100 for immersive physical interaction preferably includes a hand position/orientation (HPO) tracker 110, a user input device 120, a physical criteria generator 140, and an input translator 150, as shown in FIG. 1. The system 100 may additionally or alternatively include a body tracker 130 and/or a feedback generator 160.

The system 100 preferably enables a user to interact with a virtual environment effectively and naturally by converting physical input (e.g., hand motion, body motion, controller input) into environmental interaction in a manner responsive to user intent. The HPO tracker 110, user input device 120, and body tracker 130 serve as physical input devices for the user; the physical criteria generator 140 establishes criteria for environmental manipulation; and the input translator 150 translates data from the physical input devices into desired environmental manipulation (e.g., avatar movement, object interaction, etc.). Results of the manipulation may be conveyed to the user in a number of ways, including by the feedback generator 160.

The system 100 is preferably intended for use with a virtual environment, but may additionally or alternatively be used with any suitable environment, including an augmented reality environment. The system 100 may additionally or alternatively be used with any system controllable through one or more of the HPO tracker 110, user input device 120, and/or body tracker 130. For example, the system 100 may be used to manipulate a robotic arm. Note that while throughout the present application the term “virtual environment” will be used, a person of ordinary skill in the art will recognize that the description herein may also be applied to augmented reality environments, mechanical system control environments, or any other suitable environments.

The system 100 may provide improvements in the operation of computer systems used to generate virtual or augmented reality environments through the use of object constraints, which may reduce the complexity of calculations required to perform virtual or augmented reality generation.

The hand position/orientation (HPO) tracker 110 functions to enable natural motion interaction by precisely tracking position and orientation of a user's hands. These position and orientation values, tracked over time, are then converted into motions and/or gestures and interpreted with respect to the virtual environment by the input translator 150. Hand position and orientation are preferably tracked relative to the user, but may additionally or alternatively be tracked relative to a reference point invariant to user movement (e.g., the center of a living room) or any other suitable reference point.

The HPO tracker no preferably tracks user hand position/orientation using a magnetic tracking system, but may additionally or alternatively track user hand position/orientation using internal optical tracking (e.g., tracking position based on visual cues using a camera located within a hand controller), external optical tracking (e.g., tracking position based on visual detection of the hand or hand controller by an external camera), tracking via GPS, and/or tracking via IMU (discussed in more detail below).

The HPO tracker 110 preferably includes a magnetic tracking system substantially similar to the magnetic tracking system of U.S. patent application Ser. No. 15/152,035, the entirety of which is incorporated by this reference.

The HPO tracker 110 preferably includes a magnetic field generator in and one or more hand tracking modules 112. The magnetic field generator 111 preferably generates a magnetic field that is positionally variant; the hand tracking modules 112 sense the magnetic field, the measurement of which can then be converted to a position and orientation of the hand tracking module 112.

The magnetic field generator 111 preferably generates a temporally variant field, but may additionally or alternatively generative a temporally invariant magnetic field. In one implementation of a preferred embodiment, the magnetic field generator 111 oscillates at 38 KHz.

The magnetic field generator 111 may be located within a base station that does not move during typical operation, but may additionally or alternatively be located in any suitable area; e.g., in a backpack or a head-mounted display (HMD) worn by a user.

The hand tracking module 112 preferably includes a set of orthogonal magnetic sensing coils designed to sense a magnetic field instantiated by the magnetic field generator 111; additionally or alternatively, the hand tracking module 112 may include any suitable magnetic position/orientation sensors.

The hand tracking module 112 preferably passes sensed magnetic field information to a computing system coupled to or including in the HPO tracker 110, which computes position and orientation based on the sensed magnetic field information. Additionally or alternatively, magnetic field information sensed by the tracking module 112 may be converted by the tracking module 112 to position/orientation information before being communicated to the computing system.

In a variation of a preferred embodiment, the hand tracking module 112 includes both magnetic sensing coils and an inertial measurement unit (IMU). The IMU may include accelerometers and/or gyroscopes that record orientation and/or motion of the hand tracking module 112. IMU data is preferably used to supplement magnetic tracking data; for example, IMU data may be sampled more regularly than magnetic tracking data (allowing for motion between magnetic tracking sample intervals to be interpolated more accurately). As another example, IMU data may be used to correct or to provide checks on magnetic tracking data; for example, if IMU data does not record a change in orientation, but magnetic tracking does, this may be due to a disturbance in magnetic field (as opposed to a change in orientation of the hand controller).

In another variation of a preferred embodiment, magnetic tracking data is supplemented by external visual tracking; that is, the position and/or orientation of the hands are tracked by an external camera. Similarly to IMU data, external visual tracking data may be used to supplement, correct, and/or verify magnetic tracking data.

The user input device 120 functions to enable user input via touch, proximity, mechanical actuation, and/or other user input methods. The user input device 120 preferably serves to take input supplemental to hand and body motion (as tracked by the HPO tracker 110 and body tracker 130). The user input device 120 may include any suitable input mechanism that accepts user input via touch, proximity, and/or mechanical actuation; e.g., push-buttons, switches, touchpads, touchscreens, and/or joysticks. Alternatively, the user input device 120 may include any other input mechanism, e.g., a microphone, a lip-reading camera, and/or a pressure sensor.

Examples of user input devices 120 include gamepads, controllers, keyboards, computer mice, touchpads, touchscreens. The system 100 may include any number of user input devices 120 (including none).

The user input device 120 may be integrated with the HPO tracker 110 and/or body tracker 130 in any suitable manner; alternatively, the user input device 120 may be independent of the HPO tracker 110 and the body tracker 130.

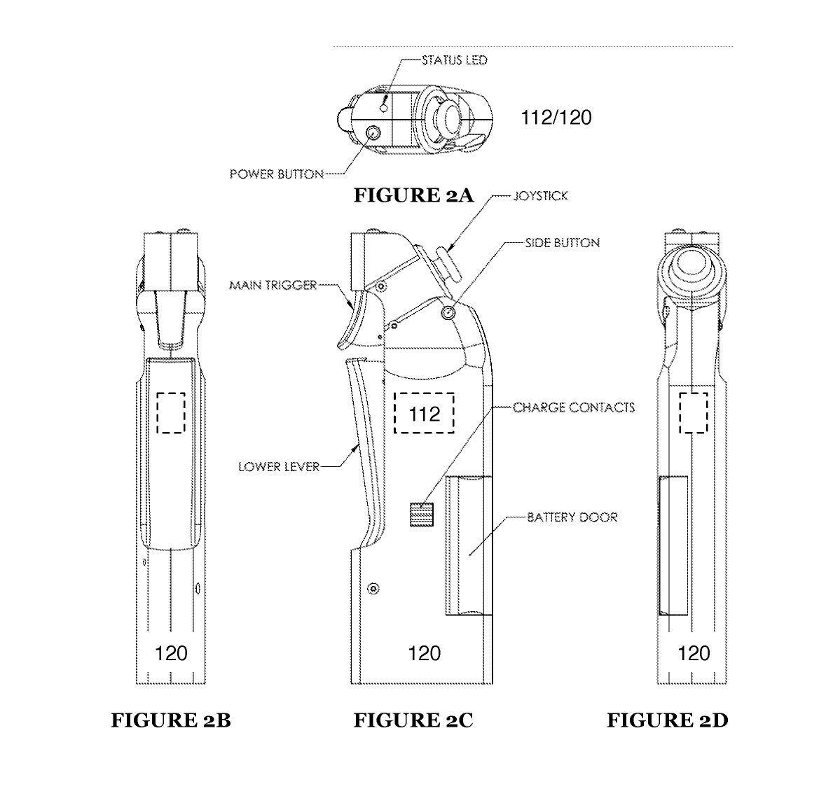

In one implementation of a preferred embodiment, the user input device 120 is a game controller with an integrated hand tracking module 112, as shown in FIGS. 2A, 2B, 2C, and 2D.

In this implementation, the game controller may include a hand strap that enables the controller to remain in a user's hand even if the user is not actively gripping the game controller. The hand strap is preferably configured so that it straps around the back of a user's hand (allowing the palm to come into contact with the controller); thus, for a right-handed controller the hand strap is preferably on the right-hand side (as viewed from the back of the controller) and for a left-handed controller the hand strap is preferably on the left-hand side (as viewed from the back of the controller). The hand strap is preferably an adjustable hand strap secured by Velcro, but may additionally or alternatively be any suitable adjustable hand strap (e.g., one adjustable via an elastic band) or a non-adjustable hand strap. The hand strap is preferably removable from the controller, but may additionally or alternatively be fixed to the controller. Alternatively, the controller may couple to a user's hand in an alternative manner (e.g., via a rigid plastic brace). The controller is preferably designed such that input controls of the controller (i.e., user input mechanisms) are positioned in easily accessible locations. Further, the controller is preferably designed to be held in a particular hand; for example, the side button of FIG. 2C is preferably easily accessible by the thumb (meaning that the view of FIG. 2C is that of a right-handed controller. Additionally or alternatively, the controller may be handedness agnostic (i.e., not designed to be held in a particular hand).

The input controls are preferably fixed to the controller, but may additionally or alternatively be removably coupled to the controller or coupled to the controller in any suitable manner. The input controls preferably include a power button, a joystick, a side button, a main trigger, and a lower lever, as shown in FIGS. 2A-2D, but may additionally or alternatively include any set of suitable input controls.

The power button is preferably positioned at the top of the controller, and functions to control power of the controller (and/or a coupled virtual reality system). The power button is preferably a binary push button; that is, the button is pushed to activate, and only two states are recognized (depressed or not). Additionally or alternatively, the power button may be positioned in any suitable location and may be actuated in any suitable manner.

The joystick is preferably positioned at the top-back of the controller, such that when the controller is gripped the user's thumb is positioned over the joystick (e.g., when a user's hand is held in a ‘thumbs up’ configuration). Additionally or alternatively, the joystick may be positioned in any suitable location. The joystick preferably enables the user's thumb to provide directional input (e.g., to navigate a character throughout a virtual world), but may additionally or alternatively be used for any suitable purpose. The joystick is preferably an analog joystick; that is, there is preferably a large number of directional states for the joystick (e.g., output of the joystick varies substantially continuously as the joystick is moved). Additionally or alternatively, the joystick may have a small number of directional states (e.g., only left, right, up, and down) similar to a d-pad. The joystick is preferably depressable; that is, pressing on the joystick actuates a button under the joystick that may be used for additional input. Additionally or alternatively, the joystick may not be depressable.

The side button is preferably positioned on a side of the controller below the joystick. The side button is preferably positioned on the left side for a right-handed controller (as viewed from behind) and on the right side for a left-handed controller (as viewed from behind). The side button is preferably positioned such that a user's thumb may be moved from the joystick to the side button without changing grip on the controller. Additionally or alternatively, the side button may be positioned in any suitable location. The side button is preferably a binary push button; that is, the button is pushed to activate, and only two states are recognized (depressed or not). Additionally or alternatively, the side button may be actuated in any suitable manner and input data may be collected in any suitable manner (e.g., side button input may vary based on actuation pressure).

The main trigger is preferably positioned at the front of the controller, such that a user's index finger rests on the main trigger when the controller is gripped. Additionally or alternatively, the main trigger may be positioned in any suitable location. The main trigger is preferably actuated by a user squeezing his or her index finger, but may additionally or alternatively be actuated in any suitable manner (e.g., by a user squeezing a middle finger).

The main trigger is preferably an analog trigger; that is, the output of the main trigger preferably varies continuously throughout the actuation arc of the trigger. Additionally or alternatively, the output of the main trigger may be discrete (e.g., the trigger is either in a depressed state or not).

The lower lever is preferably located below the main trigger such that a user's fingers (aside from the index finger) rest on the lower lever when the controller is gripped. Additionally or alternatively, the lower lever may be positioned in any suitable location. The lower lever is preferably actuated by a user squeezing his or her fingers (aside from the index finger), but may additionally or alternatively be actuated in any suitable manner. The lower lever preferably serves as an indication of grip; for example, the lower lever may be used to allow a user to ‘hold’ objects within a virtual world (while releasing the lower lever may result in dropping the virtual objects).

The lower lever is preferably an analog lever; that is, the output of the lower lever preferably varies continuously throughout the actuation arc of the lever. Additionally or alternatively, the output of the lower lever may be discrete (e.g., the lever is either in a depressed state or not).

The controller preferably communicates user input device data (e.g., button presses, etc.) to a virtual reality system with a wireless transceiver (e.g., Bluetooth, Wi-Fi, RF, etc.) but may additionally or alternatively perform communication in any suitable manner.

While this game controller is an example of HPO tracker 110 and user input device 120 integration, the HPO tracker no, user input device 120, and/or body tracker 130 may be integrated in any manner.

The body tracker 130 functions to serve as an additional position and/or orientation tracker used by the system 100 to track positions and orientations in addition to those of the HPO tracker no. For example, a body tracker 130 may be used to track position and orientation of a user's head or torso. Body trackers 130 preferably include tracking modules substantially similar to the hand tracking modules 112 of the hand controller 130, but may additionally or alternatively include any suitable tracking module. For example, a body tracker 130 may include an infrared LED (which can be tracked by an infrared camera of a virtual reality system). In a variation of a preferred embodiment, body trackers 130 are passive trackers (and may not require battery and/or active communication modules). For example, a body tracker 130 may comprise a passive RFID tag actuated by a tag reader.

The system 100 may include any number of body trackers 130 (including none).

The physical criteria generator 140 functions to set criteria for user interaction with a virtual environment. Alternatively, the physical criteria generator 140 may function to enable the generation of an augmented reality environment, mechanical control environment, and/or any other manner of environment.

The physical criteria generator 140 preferably generates a set of physical response criteria that dictate constraints for the translation of user input into virtual environment modification (performed by the input translator 150. The virtual environment preferably uses a physics engine (subject to these constraints) in conjunction with other components (e.g., graphics engines, scripting engines, artificial intelligence (AI) engines, sound engines, applications, operating systems, and/or hardware interfaces) to generate a complete and immersive VR/AR experience for a user.

The physical criteria generator 140 preferably is coupled to the physics engine of a virtual environment, but may additionally or alternatively be coupled to any virtual environment components.

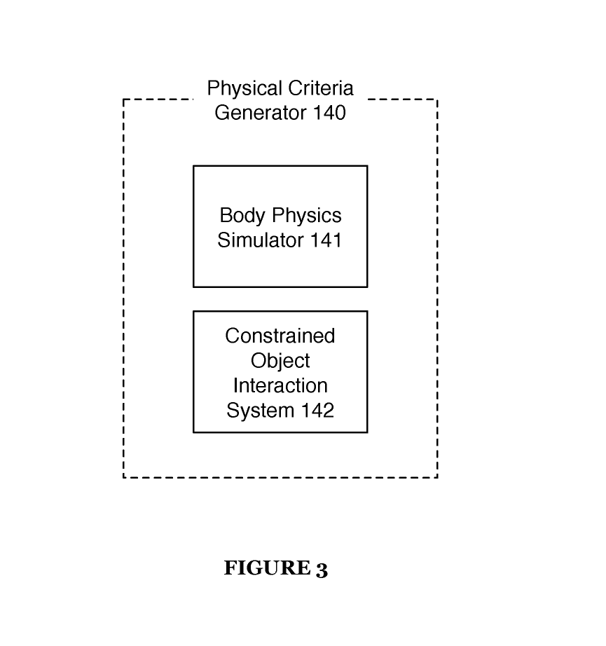

The physical criteria generator 140 preferably includes a body physics simulator 141 and a constrained object interaction system 142, as shown in FIG. 3.

The body physics simulator 141 functions to provide criteria for how the virtual environment (e.g., the physics engine) simulates interaction between a user avatar and the virtual environment. Note that the term “user avatar” as used in the present application may include any aspect of the virtual environment generally affected by user motion (as opposed to other objects or aspects of the virtual environment which are typically only affected by user motion when directly interacted with). In many cases, the user avatar may be represented by a graphical representation of a user's body (often from a first-person perspective); in this case, simulating interaction with the environment may include simulating avatar movement in response to user movement (e.g., if a user moves his/her hand, the avatar's hand should move accordingly; if the user rotates his head left the avatar's viewpoint should rotate accordingly). User avatars may also be represented in any other manner; for example, a user avatar may be a three-dimensional cursor or a two-dimensional reticle controlled by position and orientation of a user's hand.

In general, the visual aspect of avatar interaction is important to generate sensory immersion, but in some cases, the avatar may not be visible to the user. For example, a user playing as the Invisible Woman may not be able to see his/her avatar's hands in-game. In this case, natural movement of the avatar (albeit the invisible avatar) may be critical to a user's ability to interact with objects in the virtual environment, as the primary source of position feedback for the user is proprioceptive in nature.

Note that the user avatar may be generalized to a control interface within the environment; in the case of VR (and generally AR), this control interface is typically virtual. The user avatar may additionally or alternatively be represented as a real interface; for example, in a system wherein the user controls a robotic arm using hand position and orientation, the robotic arm may itself be considered a user avatar. User perspective may be a camera mounted on or positioned near the robotic arm (or the user may simply observe motion of the arm in person). Just as it is important for avatar motion to occur naturally in previous example, so is it important for the robotic arm of this example to move in a predictable and natural manner.

The previous examples focus on simulating movement of the avatar without directly referencing object interactions, which add another layer of complexity to avatar interaction simulation. For example, it may not be overly difficult to simulate the movement of an avatar's hand through air in response to similar movements of the user's hand; but what happens if the avatar's hand contacts a large object (e.g., a wall) in the virtual world? In this example, the user's hand is not in any way impaired from movement. Determining how to display the interaction between the avatar hand and the wall in such a way that preserves immersion may be incredibly difficult; if the avatar's hand stops suddenly and the user's hand keeps going, this may lead to a break in sensory immersion. Likewise, if the avatar's hand goes right through the wall, the same result may occur (perhaps unless the user is playing a ghost!).

Avatar interaction simulation is also important in real environments; for example, a robotic arm is configured to be fully extended when the user's arm is 75% extended. If the robotic arm suddenly stops after 75% extension, this may lead to a break in sensory immersion, just as in the virtual environment example.

The body physics simulator 141 preferably simulates avatar motion and avatar object interaction in a manner that preserves sensory immersion.

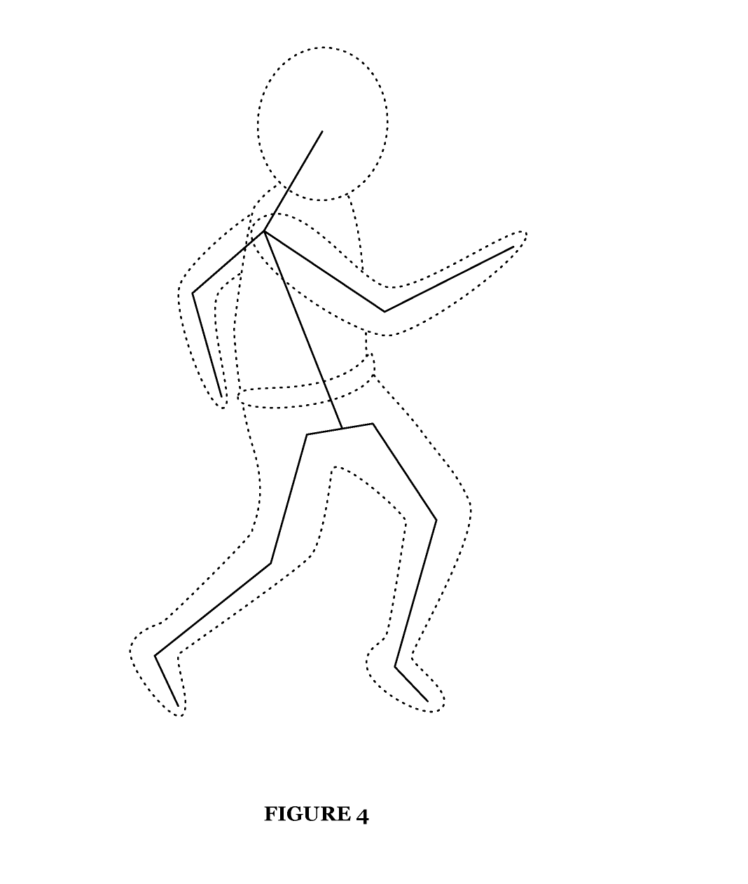

The body physics simulator 141 preferably represents the physical properties of user avatar motion with a skeleton; for example, as shown in FIG. 4. While a roughly humanoid skeleton is shown in FIG. 4, the skeleton may additionally or alternatively be any form. Motion of the skeleton is preferably constrained by bone length, position, and joint properties.

In one implementation of a preferred embodiment, skeletons are aligned initially by LookAt skeletal constraints; additionally or alternatively, skeletons may be aligned initially in any suitable manner (e.g., by rigid body transform constraints). Control positions corresponding to the skeletal constraints are preferably calculated by the input translator 150 based on user hand and/or body position.

After initial alignment, motion of the skeleton (assuming no contact with objects) is preferably simulated according to Forward And Backward Reaching Inverse Kinematics (FABRIK), but may additionally or alternatively be simulated using animation, rotational matrices, or in any manner.

To deal with object interactions, the body physics simulator 141 preferably includes a physics blending system. The physics blending system preferably allows the body physics simulator 141 to operate in either of a non-interactive and an interactive state (wherein the interaction referred to is interaction with one or more objects).

In the non-interactive state, motion is preferably simulated as described above (by a purely bone-based controller, which may operate using either inverse kinematics or animation), but may additionally or alternatively be simulated in any suitable manner.

In the interactive state, motion is preferably simulated according to a physics-based motorized ragdoll model combined with the bone-based model. The motorized ragdoll model preferably assigns spring properties to the bone model, enabling the avatar to interact naturally with a virtual environment while applying and receiving virtual physical forces.

The stiffer the springs, the greater the agreement between the bone-based model and the combined model (in fact, the bone-based model may be conceptualized as a combined model with infinitely stiff springs), but the more likely that physical interaction will result in glitches or jitters. Skeleton constraints can be very sensitive to sudden velocity and force changes (such as the massive force applied by an infinitely strong avatar on an immovable wall); by adding springiness to joints, the body physics simulator 141 sacrifices a small amount of accuracy in modeling (which may by unnoticeable) for much greater realism in physical interaction.

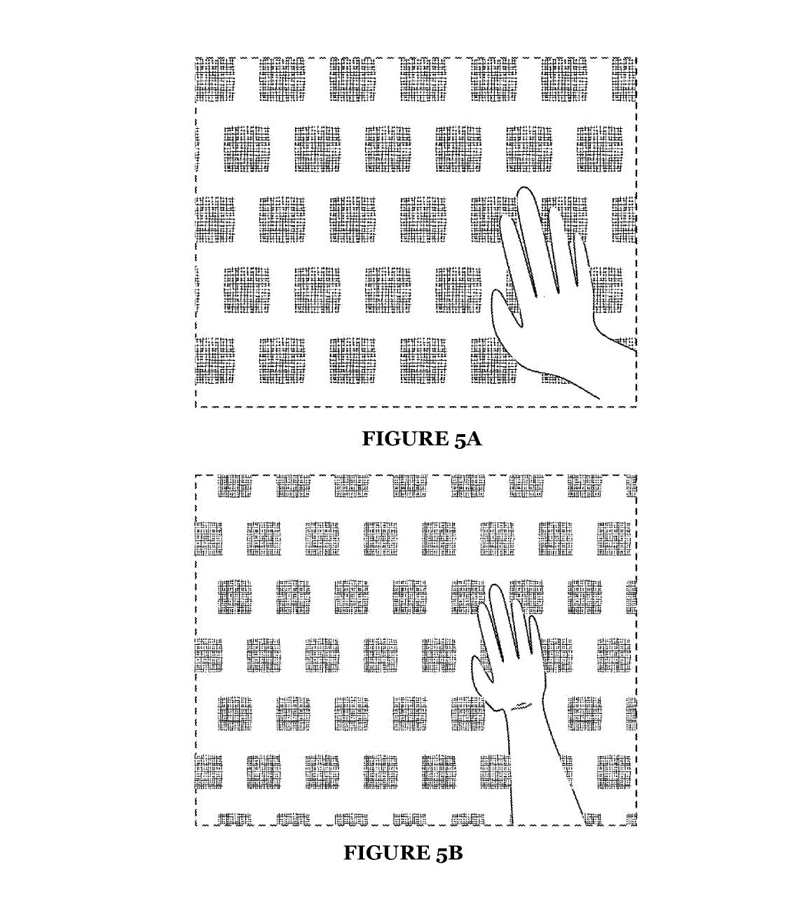

For example, if a user attempts to put his/her avatar's hand through a wall (as previously mentioned, and as shown in FIG. 5A), the body physics simulator 141 preferably engages the interactive physics model for the user avatar, resulting in the avatar's arm flexing and pushing the avatar backwards, resulting in changes to avatar perspective, arm orientation, AND location within the virtual world (as shown in FIG. 5B). Dealing with object conflicts in this way may resolve physical issues in a manner that preserves sensory immersion.

The body physics simulator 141 preferably adjusts the level of ‘springiness’ in skeleton motion by adjusting spring constants of ragdoll spring joints. The body physics simulator 141 may additionally or alternatively adjust this level of springiness by adding or reducing the number of springs connecting various parts of the ragdoll model.

In one implementation of a preferred embodiment, the body physics simulator 141 switches between non-interactive and interactive states by adjusting the spring constant from a maximum stiffness to a sub-maximal number (as opposed to ever completely turning off the spring-based modeling).

The body physics simulator 141 preferably switches between non-interactive and interactive states upon detection of interaction between the avatar and a virtual object, but may additionally or alternatively switch between non-interactive and interactive states for any reason. Interaction between the avatar and a virtual object is preferably detected by proximity of the avatar to the virtual object, but may additionally or alternatively be detected in any manner (e.g., user pressing a particular button, user pressing a button while the avatar is in proximity of a virtual object, etc.)

The body physics simulator 141 preferably sets ragdoll model parameters (e.g., spring constant) upon contact with an object in an environment; ragdoll model parameters may be set based on avatar properties (e.g., simulated avatar mass), object properties (e.g., simulated object mass), and/or contact properties (e.g., contact velocity/pressure).

The body physics simulator 141 may additionally or alternatively set ragdoll model parameters (or other physical parameters) based on any input. For example, the body physics simulator 141 may increase a model's spring constant if low rendering performance is detected.

In addition to the constraints to avatar motion as a consequence of the previously described models, the body physics simulator 141 may also include case-specific physical constraints for object interaction. That is, for interactions with specific object types, avatar position or motion may be constrained in some way.

For example, a user's avatar is climbing a ladder. The body physics simulator 141 may prevent the user's avatar from moving its hands below substantially chest level (as this movement is not generally possible for humans). The constraint may simply specify that avatar movement stops after some threshold point (e.g., even if a user's hands keep moving down, the avatar is not pushed up the ladder and the avatar's hands do not move substantially below chest level). Alternatively, the constraint may specify an alternative action; for example, the avatar's hands may be ripped from the ladder if the user attempts to move them too low. Note that this is an example of a “sticky” attachment (in contrast to a fixed attachment); that is, the body physics simulator 141 may specify a maximum interaction force that if exceeded may result in detachment (or end of object interaction, etc.). The body physics simulator 141 may additionally or alternatively specify a maximum displacement that if exceeded may result in detachment. Additionally or alternatively, the body physics simulator 141 may specify any suitable constraints that govern coupling and decoupling to virtual objects.

In the same example, physical constraints may be used to provide avatar motion without user input. The body physics simulator 141 may simulate movement of the avatar's legs to match normal human ladder climbing motion without requiring the user to actually move his/her legs up and down.

In general, the body physics simulator 141 may enforce constraints that limit avatar-object interaction to physical behavior realistic given the avatar type and environment (e.g., a tentacle beast may have no problem slithering up a ladder with full arm extension, while a human would not be able to do such a thing). The body physics simulator 141 may enforce these constraints in any suitable manner (e.g., simply placing a limit on avatar movement regardless of user movement).

The body physics simulator 141 may also include case-specific physical constraints for environmental interaction. That is, for interactions with specific environmental types, avatar position or motion may be constrained in some way. For example, an avatar is in a water environment. If the user moves his arms slowly, the avatar moves correspondingly. If the user moves his/her arms quickly, the avatar's arms may not move as quickly—but the avatar is propelled through the water. Technically, this may be simulated using the ragdoll model and treating the water as an interactive object, but it may be better for performance reasons to create case-specific physical constraints for particular environmental interactions.

Relatedly, while the body physics simulator 141 preferably simulates avatar motion in a manner appearing natural to the user, the body physics simulator 141 may additionally or alternatively intentionally provide disorienting feedback; for example, if a user's avatar has been drugged in a spy thriller game, avatar movement and/or object interaction may be simulated in an unnatural manner.

While the examples for constraint enforcement discussed herein are primarily directed to visual feedback, note that constraint enforcement may also be aided by other feedback (e.g., tactile/haptic feedback, audio feedback, etc.). These types of feedback are discussed in more detail in the section on the feedback generator 160.

The constrained object interaction system 142 functions to provide a way for avatars to interact with objects (or for objects to interact with other objects) in a physically constrained manner, which may simplify the physical processes involved in avatar-object and/or object-object interaction. The constrained object interaction system 142 preferably additionally manages coupling of virtual objects (e.g., to each other, to the avatar, etc.).

For example, a user is playing a capture the flag game; to win the game, the user must plant the flag within a flag holder. An over-realistic physics engine may require the user actually position the flag object over the flag holder for insertion; any misalignment may result in the flag not being able to be inserted. A constrained object interaction system may instead operate as follows: at the bottom of the flag pole there is an attachment point; there is a corresponding attachment point on the flag holder. When the two attachment points are within a certain range, the flag snaps to the flag holder, resulting in a simpler and more pleasant experience.

Much like with the body physics simulator 141, preserving immersion in object interaction is preferably enabled by intelligently blending between realistic physics and smooth, natural-feeling interaction.

The constrained object interaction system 142 preferably maintains sensory immersion by assigning interactive objects a limited number of interaction points, generating smooth transitions for interaction point coupling, and constraining motion when interaction points are coupled.

The constrained object interaction system 142 preferably represents objects as a composition of elements in a tree structure; including a root element (which encompasses the primary visual and physical representation of an object) and one or more leaf elements, which may correspond to interaction points, object components, and/or any other object properties.

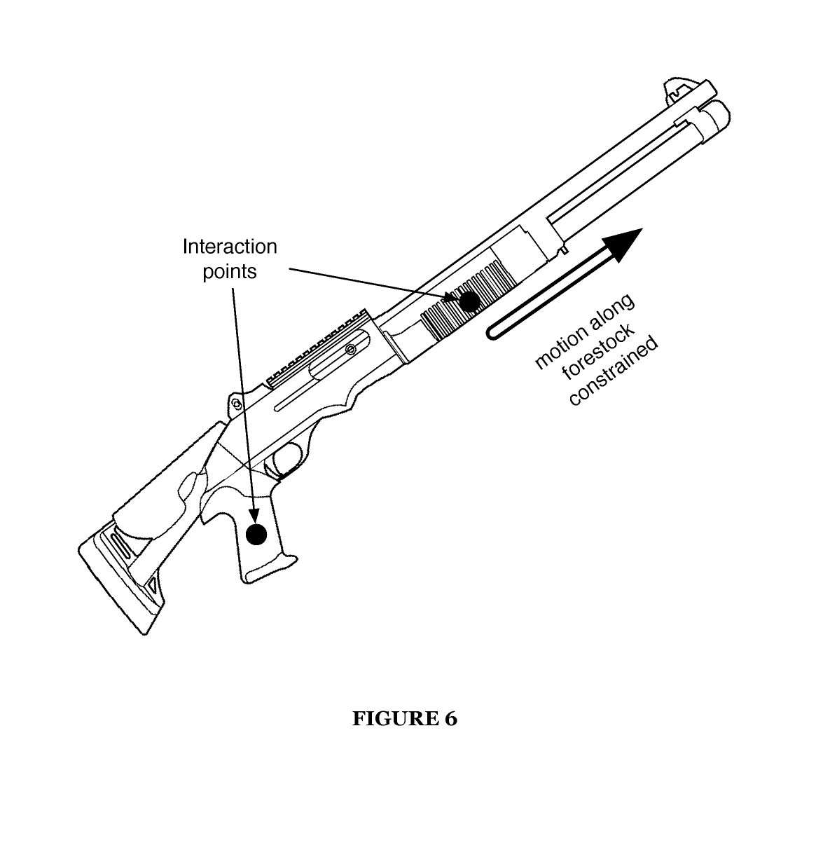

Interaction points are preferably points that may be used for user-object interaction and/or object-object interaction. For example, the previous flag/flag holder attachment example describes a set of interaction points (where the flag and flag holder couple). As another example, a virtual shotgun object may have one interaction point on a pistol grip and another on a forestock, as shown in FIG. 6.

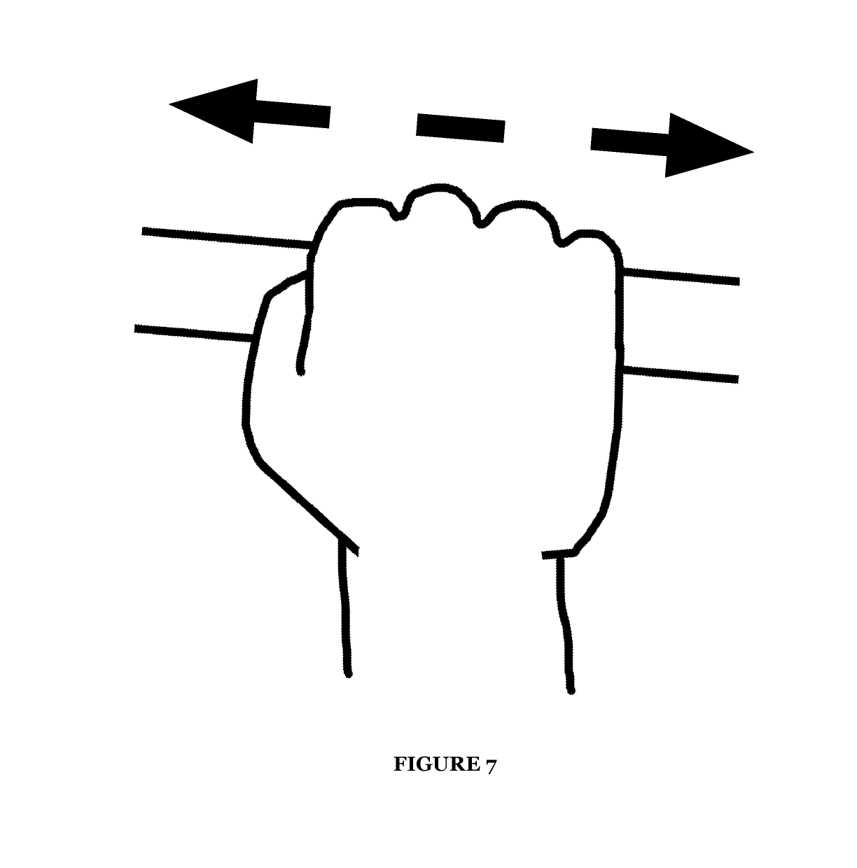

Interaction points preferably include coupling criteria. Coupling criteria defines rules for coupling with interaction points; for example, the set of objects that may couple to an interaction point (e.g., avatar hands, in the case of the virtual shotgun object). In many cases, interaction points are able to couple with only certain other interaction points (e.g., a flag pole's bottom interaction point may couple only to a flag holder and vice versa). Coupling criteria may additionally or alternatively include rules constraining motion; in one example, two coupled interaction points are fixed to each other (for instance, the handgrip of the shotgun may be fixed to the palm of an avatar's hand; rotation of the hand results in rotation of the shotgun), in another example, coupled interaction points may rotate around each other (for instance, an avatar's hand may be able to move around the surface of a ball knob of a car shifter model while still remaining coupled). As another example, an avatar's hand may be able to slide along the rung of a ladder while still remaining coupled, as shown in FIG. 7.

Note that for objects with multiple interaction points, interaction points are preferably spatially related to each other in some way. In the case of a simple object (no moving components, rigid body); e.g., a pole with two interaction points, this might mean that that the two interaction points are constrained with LookAt constraints (similar to a bone in the skeletal model). For non-rigid objects, interaction points may be linked to physics models describing the object; for example, a bending robot avatar with hands coupled to a girder may be able to bend the girder by rotating its hands while coupled to the girder (the bending defined by the object physics models).

Interaction point constraints preferably include constraint violation thresholds; that is, the extent that interaction point constraints may be violated before a modification of state must occur (e.g., decoupling of one or more interaction points). For example, a virtual object is coupled to an avatar's right hand at a first interaction point and an avatar's left hand at a second interaction point; the two interaction points separated by a distance of 0.5 m in the virtual environment. The virtual object may remain coupled at both points as long as the displacement between the avatar's right hand and left hand is less than 0.55 m and greater than 0.45 m (potentially, any change in displacement between 0.55 m and 0.45 m may not be reflected in visual feedback; i.e., the avatar hand position may not change based on user hand position, as described in previous paragraphs). While this is an example of a relative position constraint, interaction points may have any suitable constraints. For example, a set of interaction points may be related by a relative orientation constraint (e.g., the orientation of one hand must be a certain orientation relative to a second hand while coupled to the virtual object).

While the preceding paragraph gives an example of object decoupling based on violation of interaction point constraints, interaction point constraints may additionally or alternatively be used to determine if coupling can occur. For example, coupling to a second interaction point (related to a first interaction point already coupled by some interaction point constraint) may occur only if the interaction point constraint is satisfied.

Interaction points may additionally or alternatively be hierarchically organized. For example, an object with two interaction points may include a primary interaction point and a secondary interaction point. If both of these interaction points are coupled and an interaction point constraint is violated (e.g., a relative position or orientation constraint), the secondary interaction point is preferably decoupled (as opposed to the primary interaction point). Interaction point hierarchies may also define coupling order (e.g., it may be required for coupling to occur at a primary interaction point prior to coupling at a secondary interaction point) and/or any other coupling criteria.

As another example, interaction point hierarchies may affect motion of virtual objects and/or the avatar. For example, if an avatar's hands are coupled to primary and secondary interaction points, the hand coupled to the primary interaction point may be allowed to move freely (e.g., regardless of any constraints) and the virtual object will follow, while the hand coupled to the secondary interaction point may only be able to move in a manner satisfying constraints between the two interaction points.

In some cases, objects may have moveable components that are linked in some way (preferably by a physics model). This physics model preferably defines how the components move visibly (i.e., as displayed in the virtual environment) but may additionally or alternatively define how to components may move for interaction purposes as well. For example, a shotgun object may have a forestock component that is movable along the barrel axis (within a constrained region), emulating the motion of a real shotgun, in which sliding of the forestock chambers a round in the shotgun. Interaction points may be linked to objects at the component level; for example, the forestock component may be linked to an interaction point, that when coupled, fixes an avatar's hand to the forestock component. If the avatar's hand moves relative to an interaction point on the shotgun pistol grip (e.g., relative to another hand coupled to the pistol grip), and that movement is allowable by relationship constraints of the object (e.g., the avatar moves its hand along the long axis of the shotgun, and in the correct direction to ‘pump’ the shotgun object), the forestock component may move along with the hand.

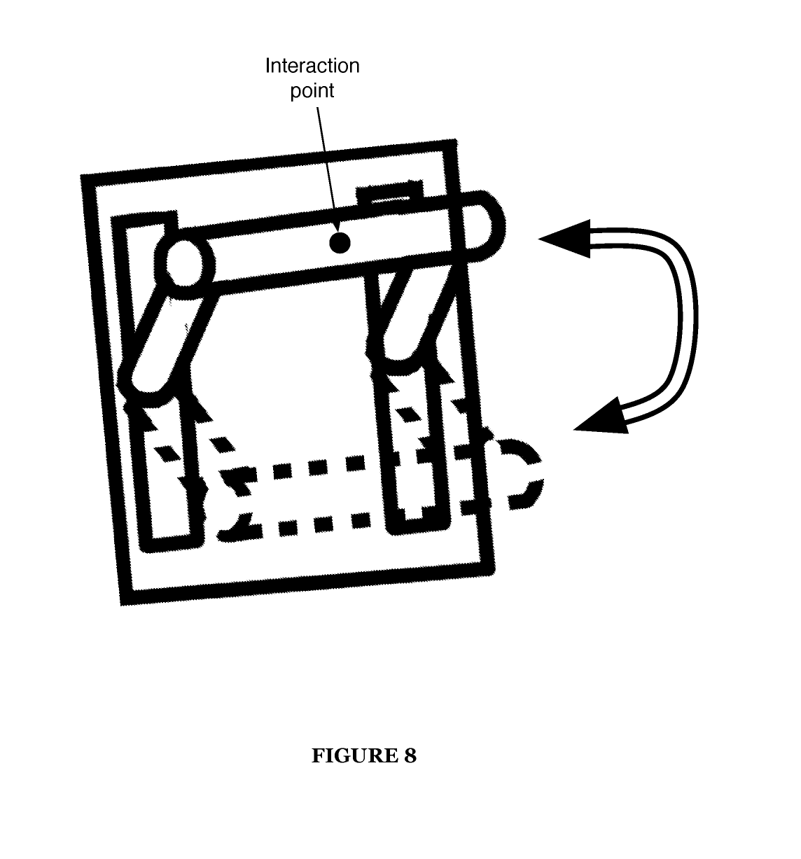

Another example of object/avatar interaction as shown in FIG. 8; in this example, the object is a switch that may be moved up in down. The switch may have binary position states (e.g., it is flipped on or off), but may additionally or alternatively have analog position states (e.g., the switch may be moved anywhere along the motion constraint arc); in this case, the switch may function analogously to an analog dimmer switch!

In an implementation of a preferred embodiment, the constrained object interaction system 142 evaluates each element in an object tree in breadth-first order, but may additionally or alternatively evaluate each element in any order. In this implementation, for an object with movable components, the constrained object interaction system 142 attempts to find optimized component positions within object constraints. In the case of hand grips, this may involve attempting to minimize the difference in a hand grip's translation and rotation to its interacting hand's tracked translation and rotation in the virtual world. Similarly, in the case of non-leaf elements, this may involve attempting to minimize the total translational and rotational offset of its child hand grips (that are currently interacted with).

While the previous examples describe how interaction points may affect motion in object-object or object-avatar coupling, interaction points may additionally or alternatively mediate any form of interaction. For example, certain movements of the avatar or object (e.g., when coupled to another object) may be recognized as corresponding to a particular state change (e.g., of the other object). For the shotgun object, correctly ‘pumping’ the shotgun preferably results in a virtual round being chambered in the shotgun object (effectively changing the state of the object or a parameter linked to the object). These state-change movements preferably satisfy any relationship constraints applicable to the movements, but may additionally or alternatively violate relationship constraints. State change movements may be defined in any manner; for example, a state change movement may be defined by a pattern of avatar or object motion. State change movements may additionally or alternatively be defined by relative positions, absolutely positions, orientations, speeds of movement, accelerations of movement, etc. As another example, firing the shotgun may result in the shotgun object applying a force to any coupled hands (i.e., recoil), resulting in movement of the shotgun and the avatar's arms.

As another example, interactions may result in transformation of objects. For example, if a pistol object is holstered, the pistol object may cease to exist as a physics-engine-simulated object while holstered (e.g., the pistol object simply appears in the virtual environment as a fixed visual model displayed on an avatar's hip).

As another example, an avatar may couple a pistol object and a silencer object by bringing interaction points in proximity to each other (this action also results in the decoupling of the silencer to the avatar's hand). In addition to fixing the visual models together (and potentially altering the physics of the combined objects), the silencer modifies operation of the pistol object (e.g., firing the pistol is quieter, recoil of the pistol object is reduced, the pistol is less accurate).

The constrained object interaction system 142 preferably dictates what actions result in interaction point coupling. For example, coupling may occur whenever two coupleable interaction points (e.g., an avatar coupling point, such as at an avatar's hand, and an object coupling point) are brought within some threshold proximity (referred to as a coupling proximity threshold). Additionally or alternatively, an action may need to be performed to accomplish interaction point coupling. For example, a user may need to press a user input device 120 button to couple the avatar's hand to a door handle. As another example, a user may need to pantomime screwing a silencer onto the threaded barrel of a pistol in order to couple a pistol object and a silencer object.

The constrained object interaction system 142 may provide feedback related to interaction point coupling. For example, a pistol object that may be picked up by an avatar may be partially transparent (to indicate that the pistol is coupleable). As another example, the constrained object interaction system 142 may display a curved arrow to a user if the avatar brings a pistol object and a silencer object in proximity; the curved arrow providing instruction to the user (to screw on the silencer object). Feedback need not necessarily be visual, feedback may additionally or alternatively be haptic, auditory, etc.

Interaction point coupling may be animated (or otherwise visually simulated) in any suitable manner. For example, two coupleable objects, when brought together, may simply snap into place. As another example, when an avatar's hand is brought in proximity to a ladder rung, interaction may be animated as showing the avatar's hand opening to grasp the rung, regardless of actual user finger position.

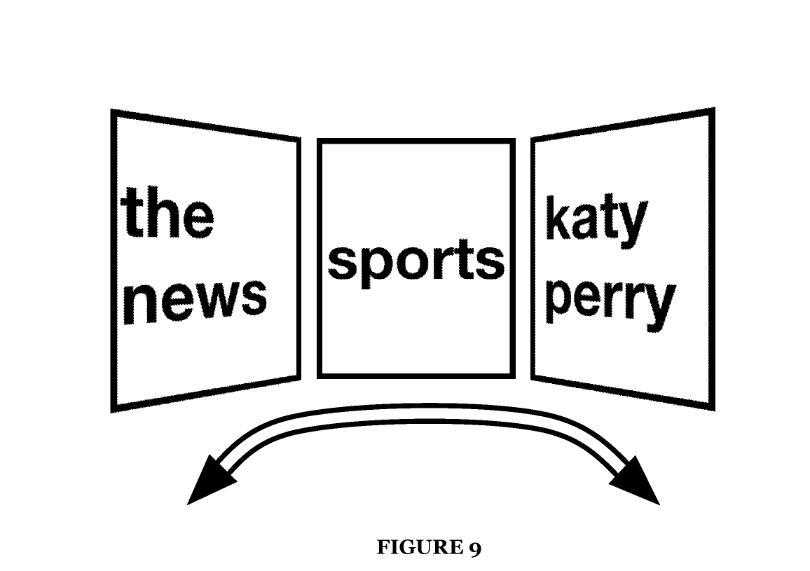

While the previous examples are primarily directed to video-game-like virtual worlds, the physical criteria generator 140 may be used to inform interaction ‘physics’ for any VR/AR (or other) scenario. For example, the physical criteria generator 140 may enable interaction with a virtual panel system, as shown in FIG. 9.

In this example, interaction with the virtual panel system may be mediated by the constraint object interaction system 142. The design of the system allows users to interact with both natively designed user-interfaces (e.g., interfaces designed for the virtual world) and foreign user-interfaces (e.g., a web-browser's or desktop OS's 2D UI). When a user reaches toward the panel (i.e., toward an interaction point linked to the panel object), the user's avatar (e.g., a floating virtual hand) may become constrained to the plane of the panel. As the user moves his/her hand around the surface of the panel, the user may be able to virtually scroll (or otherwise transition) between panels. The user may additionally or alternatively ‘select’ panels for interaction. The virtual panel system is a particularly interesting example because it enables support for the consumption of traditional content in a virtual environment in an intuitive and immersive manner.

The input translator 150 functions to transform input data received from the HPO tracker 110, user input device 120, and/or body tracker 130 into environmental manipulation. The input translator 150 interprets user input in light of criteria set by the physical criteria generator 140.

The input translator 150 preferably receives processed input data from input devices; for example, the input translator 150 preferably receives HPO tracker data as a set of hand position/orientation values (relative to some known reference). Additionally or alternatively, the input translator 150 may receive unprocessed input data from input devices (e.g., magnetic field strength readings from a magnetic field tracker), which may then be converted into processed input data.

The input translator 150 may perform any suitable filtering or processing of motion input data (including sensor fusion). For example, the input translator 150 may filter out hand tremors in received hand position data.

The input translator 150 enables the physical motion of users to result in natural-feeling interaction in a virtual environment (or AR environment, mechanical control environment, etc.).

One way in which the input translator 150 preferably enables immersive interaction is by translating user hand and/or body position/orientation into avatar position/orientation. The input translator 150 preferably sets avatar position/orientation based on a set of tracked data and as set of inferred data; but may alternatively set avatar position/orientation based on any suitable data.

For example, if the input translator receives input from the HPO tracker 110, the input translator 150 may use this input to set avatar hand position and orientation (an example of setting avatar position/orientation based on tracked data). In this example, the input translator 150 may also set avatar elbow position by inferring user elbow position from hand position/orientation data (an example of setting avatar position/orientation based on inferred data). Inferred data may include any motion, position, and/or orientation data not explicitly tracked by input devices of the system 100. As another example, the input translator 150 may infer avatar spine twist and rotation by distributing body tracker 130 data across the avatar's spine bones (while respecting individual bone constraints). If body tracker data is not available, the input translator may alternatively infer spine twist and rotation from the averaged position of both hands in relation to the pelvis. The input translator 150 preferably infers data using heuristics, but may additionally or alternatively infer data in any manner.

If an avatar is interacting with a virtual object (e.g., the avatar's hand is coupled to an interaction point of a virtual object), the input translator 150 preferably translates input in a manner consistent with the constrained object interaction system 142. For example, an avatar's right hand is coupled to a pistol grip interaction point of a virtual rifle, while the avatar's left hand is coupled to the foregrip interaction point of the virtual rifle. A small movement of a user's left hand away from the user's right hand may not translate into any movement of the avatar's left hand (since the left hand is coupled to the foregrip interaction point). A larger movement (e.g., a movement larger than some decoupling threshold) may result in decoupling of the avatar's left hand from the foregrip interaction point, at which time the avatar's left hand may move freely with the user's left hand.

The input translator 150 may additionally or alternatively translate hand position/orientation (as measured over time) into recognized gestures (i.e., the input translator 150 may perform gesture recognition). For example, if a user draws a circle twice with his/her hand, this may open an in-game menu (potentially regardless of virtual environment state, initial avatar hand position, circle size, etc.)

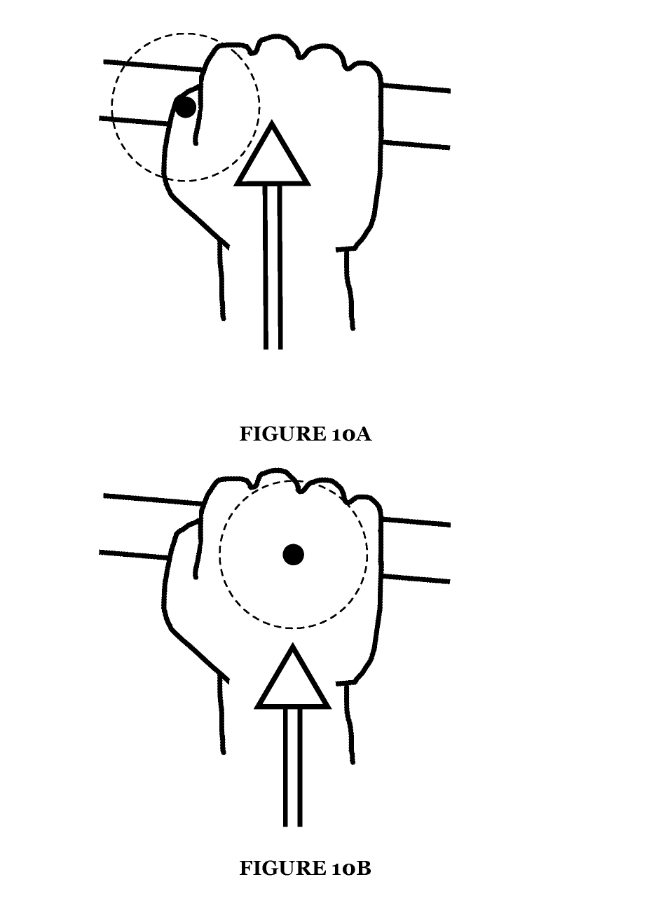

The input translator 150 preferably refines and/or calibrates input translation based on user interaction. For example, if a user consistently couples with objects near the same far edge of an interaction point proximity sphere, as shown in FIG. 10A, this may reflect a need for recalibration. The input translator 150 preferably adjusts translation from hand position to avatar position, resulting in a more calibrated interaction, as shown in FIG. 10B. The input translator 150 may additionally or alternatively perform calibration based on any other pattern observed during interactions between the avatar and objects. Alternatively, the input translator 150 may provide feedback to the user (e.g., a text bubble saying “Try moving your hand left!”) to aid in input translation.

The input translator 150 may additionally or alternatively refine input translation in any suitable manner. For example, the input translator 150 may perform interaction assistance. An example of interaction assistance is aim assist- if a user attempts to aim a virtual pistol at a target, the input translator 150 may interpolate user input between a position/orientation corresponding to the actual position/orientation of the user's hand (referred to as the raw position, which if translated directly would result in a particular pistol position/orientation) and a position/orientation of the user's hand which would result in a particular pistol position/orientation required to make a good shot (referred to as an interaction-assisted position). Interaction assistance in this manner could be adjusted based on user preferences and abilities.

The feedback generator 160 functions to provide user feedback based on user interaction with the system 100. The feedback generator 160 preferably provides haptic or tactile feedback in response to user input data (as interpreted by the system 100), but may additionally or alternatively provide any suitable feedback to a user, including visual feedback, audio feedback, etc. In one example, a user of a virtual reality system wears an exoskeleton capable of exerting force onto a user (e.g., a motorized exoskeleton that may apply force to a user's limbs). When the user contacts a virtual object in game, the feedback generator 160 may apply force to the user via the exoskeleton, simulating the physical effect of the contact.

The feedback generator 160 preferably may utilize haptic feedback in a number of ways. For instance, a hand controller may include a haptic feedback module. When the user moves his/her hand toward a virtual object that the user can interact with, the haptic feedback module (directed by the feedback generator 160) may vibrate gently to indicate the presence of an interactive object. In contrast, if the user attempts to push on a wall in the virtual environment, the haptic feedback module may vibrate substantially stronger, as an indication of the virtual forces being exerted.

Haptic feedback modules may include any suitable haptic feedback component, e.g., vibratory motors, electroactive polymers, piezoelectric actuators, electrostatic actuators, subsonic audio wave surface actuators, and/or reverse-electrovibration actuators.

### 2. Method for Immersive Physical Interaction

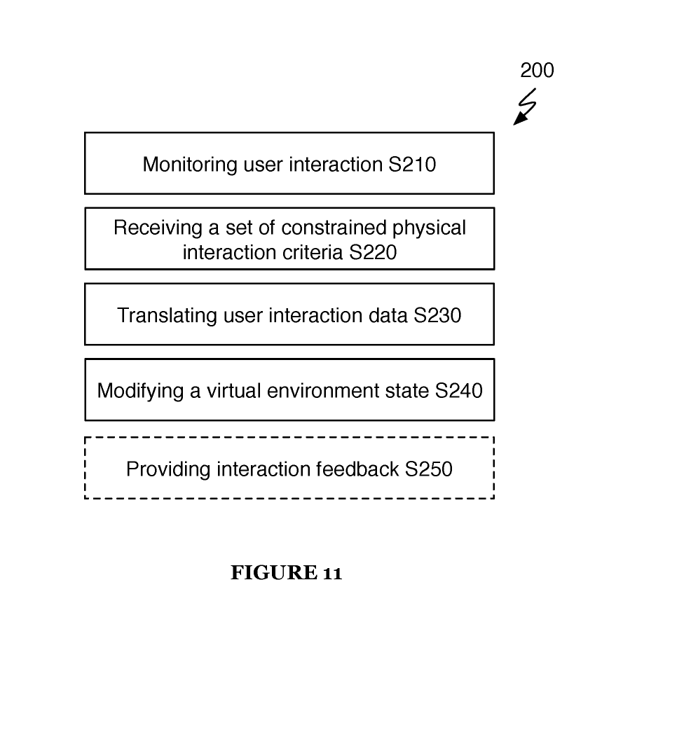

A method 200 for immersive physical interaction preferably includes monitoring user interaction S210, receiving a set of constrained physical interaction criteria S220, translating user interaction data into virtual environment modification data S230, and modifying a virtual environmental state S240, as shown in FIG. 11. The method 200 may additionally or alternatively include providing interaction feedback S250.

The method 200 functions to enable a user to interact with a virtual environment effectively and naturally by translating user input (received in S210) into environmental interaction data (S230) according to a set of constrained physical interaction criteria (e.g., physical criteria generator parameters or other criteria received in S220). From this interaction data, a virtual environment can be modified (S240), and feedback may be provided to the user (S250).

The method 200 is preferably intended for use with a virtual environment, but may additionally or alternatively be used with any suitable environment, including an augmented reality environment.

The method 200 is preferably used with the system 100 of the present application, but may additionally or alternatively be used with any system responsive to user interaction data as described in S210. For example, the method 200 may be used to manipulate a robotic arm in conjunction with a mechanical control system. Note that while throughout the present application the term “virtual environment” will be used, a person of ordinary skill in the art will recognize that the description herein may also be applied to augmented reality environments, mechanical system control environments, or any other suitable environments.

The method 200 may provide improvements in the operation of computer systems used to generate virtual or augmented reality environments through the use of object constraints, which may reduce the complexity of calculations required to perform virtual or augmented reality generation.

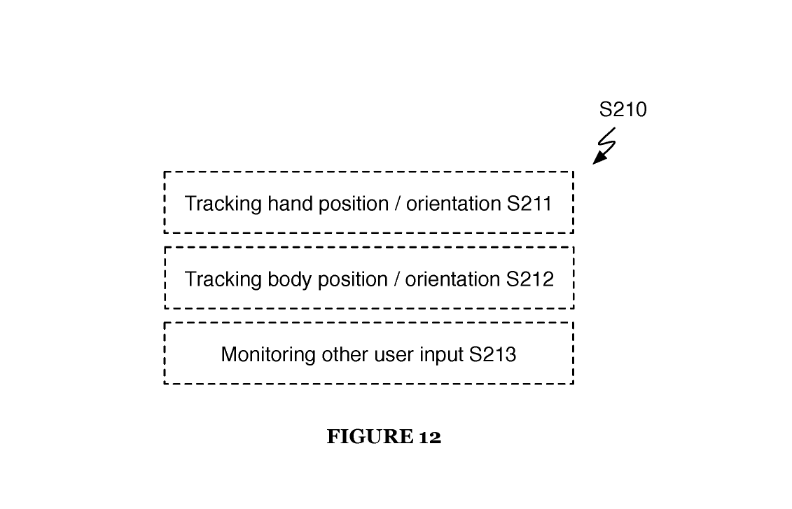

S210 includes monitoring user interaction. S210 functions to enable natural motion interaction by tracking hand position/orientation, body position/orientation, and/or other user input. S210 preferably includes tracking hand position/orientation S211, tracking body position/orientation S212, and monitoring other user input S213, as shown in FIG. 12.

S211 functions to enable natural motion interaction by precisely tracking position and orientation of a user's hands. These position and orientation values, tracked over time, may be translated into motions and/or gestures and interpreted with respect to the virtual environment. Hand position and orientation are preferably tracked relative to the user, but may additionally or alternatively be tracked relative to a reference point invariant to user movement (e.g., the center of a living room) or any other suitable reference point.

S211 preferably includes tracking hand position/orientation using a magnetic tracking system as described in the system 100, but may additionally or alternatively track user hand position/orientation using internal optical tracking (e.g., tracking position based on visual cues using a camera located within a hand controller), external optical tracking (e.g., tracking position based on visual detection of the hand or hand controller by an external camera), tracking via GPS, and/or tracking via IMU (discussed in more detail below).

In a variation of a preferred embodiment, S211 includes tracking hand position/orientation using both magnetic sensing coils and an inertial measurement unit (IMU). The IMU may include accelerometers and/or gyroscopes that record hand orientation and/or motion. IMU data is preferably used to supplement magnetic tracking data; for example, IMU data may be sampled more regularly than magnetic tracking data (allowing for motion between magnetic tracking sample intervals to be interpolated more accurately). As another example, IMU data may be used to correct or to provide checks on magnetic tracking data; for example, if IMU data does not record a change in orientation, but magnetic tracking does, this may be due to a disturbance in magnetic field (as opposed to a change in orientation).

In another variation of a preferred embodiment, magnetic tracking data is supplemented by external visual tracking; that is, the position and/or orientation of the hands are tracked by an external camera. Similarly to IMU data, external visual tracking data may be used to supplement, correct, and/or verify magnetic tracking data.

Tracking body position/orientation S212 functions to track positions and orientations in addition to hand positions/orientations. For example, body tracking may be used to track position and orientation of a user's head or torso. Body tracking preferably includes using tracking modules substantially similar to those used for tracking hand position/orientation, but may additionally or alternatively include using any suitable tracking module. For example, body tracking may include visually tracking an infrared LED attached to a user's body. In a variation of a preferred embodiment, body tracking may include performing passive tracking (which may not require battery and/or active communication from body tracking modules). For example, body tracking may comprise interrogating a passive RFID tag with a tag reader.

Monitoring other user input S213 functions to enable user input via touch, proximity, mechanical actuation, and/or other user input methods. S213 preferably serves to take input supplemental to hand and body motion. S213 may include monitoring input using any suitable input mechanism that accepts user input via touch, proximity, and/or mechanical actuation; e.g., push-buttons, switches, touchpads, touchscreens, and/or joysticks. Alternatively, S213 may include using any other input mechanism, e.g., a microphone, a lip-reading camera, and/or a pressure sensor.

S220 includes receiving a set of constrained physical interaction criteria. S220 preferably includes receiving any criteria that dictate user interaction with a virtual environment (and/or an augmented reality environment, mechanical control environment, etc.)

Physical interaction criteria preferably dictate constraints for the translation of user input into virtual environment modification, which preferably occurs via a physics engine in conjunction with other components (e.g., graphics engines, scripting engines, artificial intelligence (AI) engines, sound engines, applications, operating systems, and/or hardware interfaces).

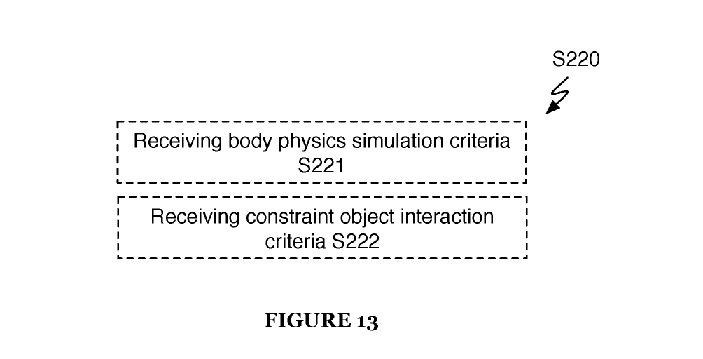

S220 preferably includes receiving body physics simulation criteria S221 (as described in the sections regarding the body physics simulator 141) and receiving constrained object interaction criteria S222 (as described in the sections regarding the constrained object interaction system 142), as shown in FIG. 13. Additionally or alternatively, S220 may include receiving, modifying, and/or generating physical interaction criteria in any manner.

Constrained object criteria may, for example, include coupling proximity thresholds, decoupling proximity thresholds, relative position constraints, relative orientation constraints, interaction point hierarchy information, and/or any other criteria related to avatar-object or object-object interactions.

S230 includes translating user interaction data into virtual environment modification data. S230 functions to transform user input data into environmental manipulation data according to the physical interaction criteria received in S220. S230 preferably includes translating user interaction data in a substantially similar manner to the input translator 150, but may additionally or alternatively include translating user interaction data in any manner.

As described in the sections on the input translator 150, S230 may include translating user interaction data into avatar interaction data based on environmental criteria (e.g., of the virtual environment), object interactions (e.g., interactions between the avatar and objects of the virtual environment), and any other suitable information.

S230 may additionally or alternatively include translating user interaction data into virtual environment modification data in any other manner as described in the system 100 description.

S240 includes modifying a virtual environmental state. S240 functions to modify virtual environment parameters according to user interaction data received in S210 (and translated in S230). S240 preferably includes modifying virtual environmental state by updating configuration databases linked to the virtual environment, but may additionally or alternatively modify virtual environmental state in any manner. For example, a user reaches out to grab a virtual gun. The user's movements are monitored in S210, and are translated into an intended action by S230 (i.e., to couple the gun to the user's avatar's hand). In this case, S240 may include updating database entries relating to the position and state (e.g., coupling status) of the virtual gun and of the user's avatar's hand. S240 preferably occurs substantially in real-time, but may additionally or alternatively occur on any time scale. S240 may additionally or alternatively include modifying a virtual environmental state in any other manner as described in the system 100 description.

S250 preferably includes providing interaction feedback in a substantially similar manner to the feedback generator 160. Additionally or alternatively, S250 may include providing any suitable interaction feedback, including providing visual, auditory, olfactory, kinesthetic, tactile, gustative, and/or haptic feedback based on user interaction.

The methods of the preferred embodiment and variations thereof can be embodied and/or implemented at least in part as a machine configured to receive a computer-readable medium storing computer-readable instructions. The instructions are preferably executed by computer-executable components preferably integrated with a system for natural motion interaction. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

We claim:

1. A method for immersive physical interaction includes:
receiving constrained object interaction criteria;
tracking a first hand position and a first hand orientation of a first hand of a user;
tracking a second hand position and a second hand orientation of a second hand of the user;
translating the first hand position and the first hand orientation into a first virtual hand position and a first virtual hand orientation of a user avatar in a virtual environment;
upon satisfaction of a coupling proximity threshold by a proximity of a first interaction point of a virtual object and the first virtual hand position, coupling the virtual object, at the first interaction point, to the user avatar; and
modifying the position and orientation of the virtual object based on the first virtual hand position, the first virtual hand orientation, and the constrained object interaction criteria.

2. The method of claim 1, further comprising:
translating the second hand position and the second hand orientation into a second virtual hand position and a second virtual hand orientation of the user avatar; and
upon satisfaction of the coupling proximity threshold by a proximity of a second interaction point of the virtual object and the second virtual hand position, coupling the virtual object, at the second interaction point, to the user avatar;
wherein modifying the position and orientation of the virtual object comprises modifying the position and orientation of the virtual object based on the first virtual hand position, the first virtual hand orientation, the second virtual hand position, the second virtual hand orientation, and the constrained object interaction criteria.

3. The method of claim 2, wherein the first interaction point is a primary interaction point and the second interaction point is a secondary interaction point.

4. The method of claim 3, wherein the constrained object interaction criteria defines a relative position constraint and a relative orientation constraint; wherein coupling the virtual object, at the second interaction point, to the user avatar comprises coupling the virtual object, at the second interaction point, only if the relative orientation constraint is satisfied by the second virtual hand orientation relative to the first virtual hand orientation.

5. The method of claim 3, wherein the constrained object interaction criteria defines a relative position constraint and a relative orientation constraint; further comprising decoupling the virtual object, at the second interaction point, from the user avatar in response to a violation of the relative orientation constraint by the second virtual hand orientation relative to the first virtual hand orientation; wherein modifying the position and orientation of the virtual object after decoupling comprises modifying the position and orientation of the virtual object based only on the first virtual hand position, the first virtual hand orientation, and the constrained object interaction criteria.

6. The method of claim 5, wherein the violation of the relative orientation constraint is due to a change of the first virtual hand position and first virtual hand orientation without a corresponding change in the second virtual hand position and second virtual hand orientation.

7. The method of claim 5, wherein the violation of the relative orientation constraint is due to a change of the second virtual hand position and second virtual hand orientation without a corresponding change in the first virtual hand position and first virtual hand orientation.

8. The method of claim 3, wherein the constrained object interaction criteria defines a relative position constraint and a relative orientation constraint; wherein translating the first hand position and the first hand orientation comprises translating the first hand position and the first hand orientation into the first virtual hand position and the first virtual hand orientation regardless of the relative position constraint and the relative orientation constraint; wherein translating the second hand position and the second hand orientation comprises translating the second hand position and the second hand orientation into the second virtual hand position and the second virtual hand orientation according to the relative position constraint and the relative orientation constraint.

9. The method of claim 8, wherein the virtual object comprises a first virtual object component, coupled to the first interaction point, and a second virtual object component, coupled to the second interaction point; wherein the first virtual object component may move relative to the second virtual object component subject to relationship constraints of the virtual object.

10. The method of claim 9, further comprising modifying a state of the virtual object in response to recognition of a movement of the second virtual hand position relative to the first virtual hand position as a state-change movement of the virtual object; wherein the movement satisfies the relationship constraints of the virtual object.

11. The method of claim 10, wherein the movement results in a visible movement of the first object component relative to the second object component; wherein the visible movement is determined by a physics model, the physics model linking the first object component and the second object component.

12. The method of claim 2, wherein modifying the position and orientation of the virtual object comprises interpolating the position and orientation of the virtual object between a raw position and orientation and an interaction-assisted position and orientation.

13. The method of claim 2, further comprising inferring a spine rotation of the user avatar from the first virtual hand position and the second virtual hand position.

14. A system for immersive physical interaction comprises:
a hand position and orientation tracker that tracks a first hand position and a first hand orientation of a first hand of a user and tracks a second hand position and a second hand orientation of a second hand of the user;
a physical criteria generator comprising a body physics simulator and a constrained object interaction system; wherein the body physics simulator simulates avatar motion; wherein the constrained object interaction system manages virtual object coupling; and
an input translator that translates the first hand position and the first hand orientation into a first virtual hand position and a first virtual hand orientation of a user avatar in a virtual environment and translates the second hand position and the second hand orientation into a second virtual hand position and a second virtual hand orientation of the user avatar.

15. The system of claim 14, wherein the constrained object interaction system represents a virtual object as a composition of elements in a tree structure; wherein the virtual object includes a root element, comprising a primary visual representation and a primary physical representation of the first virtual object, and a first leaf element, corresponding to a first interaction point; wherein the constrained object interaction system enables coupling of the virtual object, at the first interaction point, to the user avatar based on satisfaction of a coupling proximity threshold.

16. The system of claim 15, wherein the virtual object further includes a second leaf element, corresponding to a second interaction point; wherein the constrained object interaction system enables coupling of the virtual object, at the second interaction point, to the user avatar based on satisfaction of the coupling proximity threshold.

17. The system of claim 16, wherein the first interaction point is a primary interaction point and the second interaction point is a secondary interaction point.

18. The system of claim 17, wherein the constrained object interaction system defines a relative position constraint and a relative orientation constraint; wherein the constrained object interaction system enables coupling the virtual object, at the second interaction point, to the user avatar only if the relative orientation constraint is satisfied by the second virtual hand orientation relative to the first virtual hand orientation.

19. The system of claim 15, wherein the input translator calibrates input translation based on a detected pattern in the first virtual hand position relative to the first interaction point at satisfaction of the coupling proximity threshold.

20. The system of claim 14, wherein the hand position and orientation tracker comprises a magnetic field generator, a first magnetic hand tracking module, and a second magnetic hand tracking module; wherein the first magnetic hand tracking module tracks the first hand position and the first hand orientation; wherein the second magnetic hand tracking module tracks the second hand position and the second hand orientation.

21. The system of claim 14, wherein the body physics simulator includes a physics blending system; wherein the body physics simulator simulates avatar motion using a purely bone-based model when the body physics simulator is in a non-interactive state; wherein the body physics simulator simulates avatar motion using a combination model, the combination model combining a bone-based model and a motorized ragdoll model.
